(19) United States
(12) Patent Application Publication
(10) Pub. No.: US 2011/0300512 A1
(43) Pub. Date: Dec. 8, 2011

(54) APEX LOCATOR MOUNTABLE ON A HANDPIECE

(75) Inventors: Arik Becker, Kibbutz Afikim - Doar-Na Emek HaYarden (IL); Amit Avigdor, Moshav Yanuv (IL); Hagai Harduf, Binyamina (IL); Doron Krom, Zikhron-Yaakov (IL)

(73) Assignee: MedicN.R.G. Ltd., Kibbutz Afikim - Doar-Na Emek HaYarden (IL)

(21) Appl. No.: 13/201,634

(22) PCT Filed: Feb. 18, 2010
(86) PCT No.: PCT/IL2010/000144

§ 371 Date: Aug. 16, 2011

Related U.S. Application Data
(60) Provisional application No. 61/202,327, filed on Feb. 19, 2009.

(51) Int. Cl. A61C 5/02; B23P 19/00; B23P 13/00

(52) U.S. Cl. 433/224; 29/896.1; 29/700

(57) ABSTRACT

An apex locator for measuring a root canal apex, comprising:

a first connection adapted for removably electrically connecting the apex locator to a file or reamer held by a motorized handpiece; and a second connection connected to a lip hook.

### RELATED APPLICATION/S

This application claims from the benefit of U.S. provisional application No. 61/202,327 filed on Feb. 19, 2009.

The contents of the above documents are incorporated by reference as if fully set forth herein.

### FIELD AND BACKGROUND OF THE INVENTION

The present invention, in some embodiments thereof, relates to an apparatus and method for determining the distance of a probe from the apex of a root during a root canal procedure.

In root canal therapy, the interior of a root is removed with a dental probe, such as a reamer or file, prior to filling the root with replacement material. If all the root material not completely removed from the root prior to filling with replacement material, leftover root material can retard healing and even act as a focus for infection. On the other hand, if the probe is entered too deeply in the root canal, the probe penetrates the jaw tissue and causes swelling and unnecessary trauma to the patient.

It is therefore important to determine the exact location of the root canal apex in order to determine how far to clean the root canal. Several apparatuses and methods are known in the art for locating an apex of a root canal.

Some of the devices of the prior art are stand-alone devices which are used for apex location only. The apex locator is used for determining the location of the root canal apex and a file or handpiece is then used in order to remove the root material down to the apex.

International Patent Publication WO 2008/155751 to MedicN.R.G., for example, discloses an apex locator comprising a probe and an electrode for touching a soft tissue in the mouth. A voltage is applied to the probe upon which a signal responsive to the position of the probe and the voltage is received. Two response waveforms are then generated from the signal and the distance of the probe from the apex is estimated utilizing both waveforms.

Other prior art devices include a file or handpiece with an integral apex locator.

A “handpiece” is a term commonly used in the art and refers to a hand held dental instrument used to hold rotary instruments such as files or reamers. A handpiece includes a body portion including a motor and a head. The head is attached to the body portion at one end and has a holder for the rotary instruments at the other end. A handpiece may be connected by a cable to a power source or include a power source in the handpiece itself.

US Publication No. 2008/0241783 to Yamashita et al. for example discloses a handpiece with an integral apex locator which enables on-line measurement of the apex during treatment.

Additional background art includes U.S. Pat. No. 6,968,229 to Siemons A., U.S. Pat. No. 6,425,875 to Reifman et al., U.S. Pat. No. 5,759,159 to Masreliez C. J., U.S. Pat. No. 5,902,105 to Uejuma et al., U.S. Pat. No. 5,295,833 to Chihiro et al., U.S. Pat. No. 5,211,556 to Kobayashi et al., U.S. Pat. No. 5,897,315 to Nakayama et al., U.S. Pat. No. 5,980,248 to Kusakabe et al., U.S. Pat. No. 6,929,476 to Katsuda et al. and U.S. Pat. No. 6,315,557 to Messick.

### SUMMARY OF THE INVENTION

An aspect of some embodiments of the invention relates to an apex locator which is adapted to fit on existing handpiece.

According to an aspect of some embodiments of the present invention there is provided an apex locator for measuring a root canal apex, comprising:

a first connection adapted for removably electrically connecting the apex locator to a file or reamer held by a motorized handpiece; and

a second connection connected to a lip hook.

According to some embodiments, the apex locator is also removably mechanically mounted on the handpiece. According to some embodiments, the apex locator is connected to the file or reamer by a cable.

According to some embodiments, the apex locator is electrically connected to the file or reamer by an adaptor mounted on the handpiece. According to some embodiments, the adaptor is configured for mounting on handpieces of different diameters. According to some embodiments, the adaptor is mounted on the handpiece and the apex locator is mounted on the adaptor. According to some embodiments, the adaptor and apex locator are an integral unit.

According to some embodiments, the adaptor is configured for electrically connecting to the file or reamer by an electrical connection between a head and motor of the handpiece. According to some embodiments, the adaptor is configured for electrically connecting to the file or reamer by connecting to an external surface of a head of the handpiece.

According to some embodiments, the apex locator further includes an outlet for removably connecting the apex locator to a non-motorized probe.

According to an aspect of some embodiments of the invention, there is provided, an adaptor adapted to removably electrically connect an apex locator to a motorized handpiece, the adaptor comprising:

an apex locator connector portion for electrical connection to the apex locator;

a handpiece connector portion adapted for removably electrically connecting to the motorized handpiece; and

an electrically conductive portion connecting the apex locator connector portion and the handpiece connector portion.

According to some embodiments, the apex locator connector portion is adapted for removably mechanically mounting the apex locator to the adaptor.

According to some embodiments, the adaptor is adapted for mechanically mounting on an existing handpiece. According to some embodiments, the adaptor is adapted for mechanically mounting on handpieces of different diameters.

According to some embodiments, the handpiece includes a body portion containing a motor and a file or reamer head portion removably attachable to the body portion, and wherein the handpiece connector portion is adapted to be inserted in a space between the head and body portions.

According to some embodiments, the handpiece connector portion is adapted to be electrically connected to an external surface of a head of the handpiece.

According to some embodiments, the adaptor is adapted to be mechanically mounted onto handpieces of different lengths.

According to an aspect of some embodiments of the invention, there is provided a method of retrofitting an existing handpiece, the method comprising:

removably electrically connecting a first outlet of an apex locator to a file or reamer held by a motorized handpiece; and

connecting a second outlet of the apex locator to a lip hook.

According to some embodiments, removably electrically connecting further comprises:

electrically connecting the apex locator to an adaptor; and

electrically connecting the adaptor to the file or reamer held by the handpiece.

According to some embodiments, electrically connecting the adaptor to the file or reamer held by the handpiece comprises electrically connecting the adaptor between a head and motor of the handpiece.

According to some embodiments, the method further comprises mechanically mounting the adaptor on the handpiece. According to some embodiments, mechanically mounting the adaptor to the handpiece comprises fitting the adaptor to the diameter of the handpiece. According to some embodiments, mechanically mounting the adaptor to the handpiece comprises fitting the adaptor to the length of the handpiece.

According to some embodiments, the method further comprises mechanically mounting the apex locator on the adaptor.

According to some embodiments, electrically connecting the apex locator to an adaptor is performed by mechanically mounting the apex locator on the adaptor.

According to an aspect of some embodiments of the invention, there is provided, a method of measuring and treating a root canal, the method comprising:

removably electrically connecting an apex locator on a motorized handpiece for root canal treatment; and

measuring the root apex by the apex locator during treatment by the handpiece.

According to some embodiments, measuring comprises:

electrically connecting the apex locator to a file or reamer; and

processing, by the apex locator, signals received from the file or reamer.

According to some embodiments, the method further comprises:

electrically connecting the apex locator to a non-motorized probe; and

processing, by the apex locator, signals received from the probe.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a schematic illustration of an apex locator connected to a non-motorized probe in accordance with some embodiments of the invention;

FIGS. 2A and 2B are schematic exploded illustrations of the apex locator shown in the embodiments of FIG. 1 with an adaptor for connection to a handpiece in accordance with some exemplary embodiments of the invention;

FIGS. 2C and 2D are schematic illustrations of two views of an apex locator connected to a handpiece with the adaptor shown in FIGS. 2A and 2B.

FIG. 2E is an enlarged and partially cut-away view of the connection illustrated in FIG. 2D;

FIG. 3A is a schematic illustration of an apex locator and adaptor for connection to a handpiece in accordance with some other exemplary embodiments of the invention;

FIG. 3B is a schematic illustration of an apex locator connected to a handpiece with the adaptor shown in FIG. 3A;

FIGS. 4A and 4B are schematic illustrations of an adaptor for connection to a handpiece in accordance with yet another embodiment of the present invention; and

FIG. 5 is a schematic illustration of a brush electrically connecting a file to a head of a handpiece.

### DESCRIPTION OF SPECIFIC EMBODIMENTS OF THE INVENTION

The present invention, in some embodiments thereof, relates to an apparatus and method for determining the distance of a probe from the apex of a root during a root canal procedure. The distance of a probe from the apex is preferably determined during periods between when the file or reamer held by the handpiece is rotating, for example during periods when the handpiece is drilling.

An aspect of some embodiments of the invention relates to an apex locator adapted to be electrically connected to existing handpieces holding files or reamers for cleaning out root canals. Optionally, the apex locator is also mechanically mounted onto the handpiece.

In order to distinguish between mechanical and electrical connection, in the description that follows the verb “connect” will be used to refer to electrical connection and the verb “mount” will be used to refer to mechanical connection.

An aspect of some embodiments of the invention relates to an apex locator which is adapted for root canal measurement without being permanently or integrally connected to a handpiece or file or reamer. The term “integral” as used herein refers to having a common housing.

An aspect of some embodiments of the invention relates to an apex locator which is adapted to be removably electrically connected to a file, reamer or handpiece. The term “removably connected” or “removably mounted” as used herein refers to a connection which can be easily separated and connected again, for example a connection that can be separated without unscrewing any screws or the like. In some embodiment, “removably” refers to a connection that can be separated using one hand or by performing a single action.

The inventors of the present application have discovered that for almost existing handpieces holding files or reamers the space between the head of the handpiece and the motor of the handpiece can be accessed (for example by removing the head) allowing an electrical connection with the reamer or file tip. Thus, it is possible to electrically connect an adapter to which the apex locator is also electrically connected at this point, such that the file or reamer acts as a probe for the apex locator.

In addition, in most handpieces the head is made from a conductive material. Thus, for some embodiments, it is possible to allow an electrical connection to the file or reamer by electrically connecting to the conductive material of the head.

In some embodiments of the invention the removable apex locator can be used either when it is connected to the handpiece via the adaptor, or, as a stand alone unit, for example, when it is removed from the handpiece.

According to some embodiments of the invention, there is provided an adaptor which is adapted to provide removable electrical connection between an apex locator and a handpiece. The apex locator is electrically connected on one side of the adaptor and a handpiece is electrically connected to another side of the adaptor. The adaptor, according to some embodiments, provides electric connection between the file held by the handpiece and the apex locator. Root apex is measured using signals received from the file, through the adaptor, to the apex locator.

In some embodiments, the adaptor is removably electrically connected to the apex locator and handpiece such that the apex locator and the handpiece can be connected and detached from each other as desired.

In some embodiments, the adaptor is also removably mechanically mounted onto the handpiece. Optionally, the apex locator is removably mechanically mounted onto the adaptor. Alternatively, the adaptor is an integral part of the apex locator and is removed from the handpiece together with the apex locator.

In some embodiments, the adaptor is electrically connected to the handpiece between the head of the handpiece and the motor of the handpiece. In other embodiments, the adaptor is electrically connected to the external surface of the head of the handpiece. Preferably, electrical connection of the apex locator through the adaptor to the handpiece does not have any effect on the normal operation of the handpiece.

An aspect of some embodiments of the invention relates to an apex locator which is used both for initial root canal measurement and for root canal measurement during treatment.

According to some embodiments of the invention, the apex locator is further adapted for measuring a root canal by being connected to a non-motorized probe, without being connected to an adaptor or handpiece as described above.

An aspect of some embodiments of the invention relates to a method of root canal therapy wherein the apex locator is used for initial measurement by being connected to a non-motorized probe and the apex locator is further used for root canal measurement during treatment by being connected to a handpiece via an adaptor as for example described above.

An aspect of some embodiments of the invention relates to a method of retrofitting an existing handpiece. According to some embodiments of the invention, an existing handpiece is retrofitted by providing apex locating capabilities to the handpiece. In some embodiments, an apex locator is electrically connected to the handpiece, optionally by use of an adaptor as described above. Optionally, the apex locator is removably mounted onto the handpiece.

Measurement of the root apex with the apex locator may be performed (whether attached to or detached from the handpiece) according to any method known in the art, for example according to the methods described in WO 2008/155751 or U.S. Pat. No. 7,326,053, both assigned to MedicN.R.G. Ltd. or any other method of apex locating.

Before explaining several embodiments of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

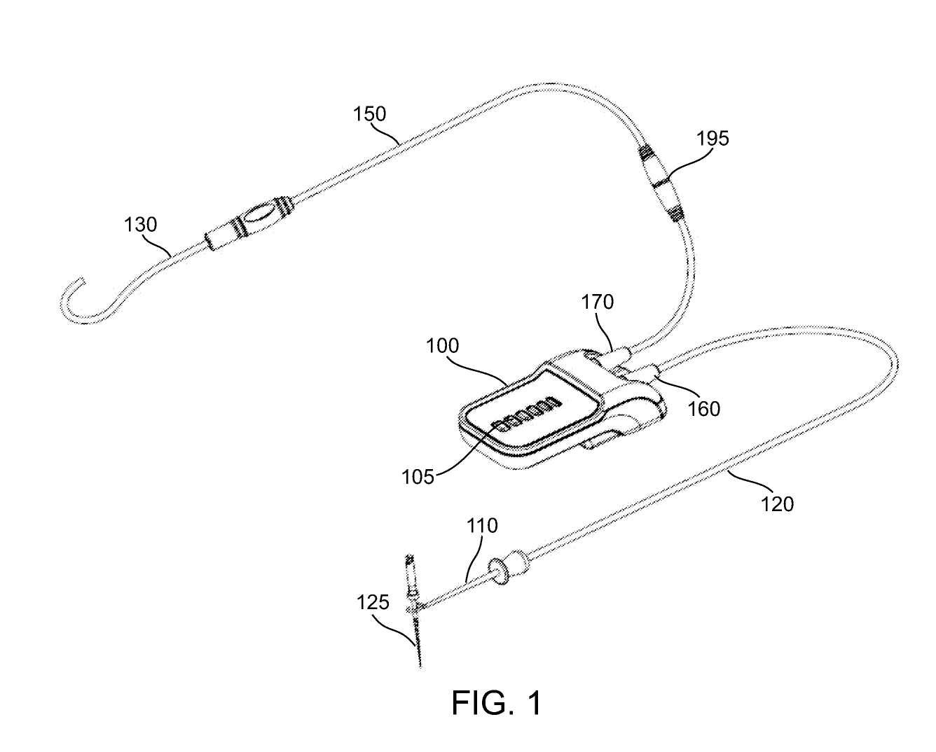

Reference is now made to FIG. 1, showing an apex locator 100 used for initial measurement of the root canal in accordance with some embodiments of the invention. Apex locator 100 is shown connected to a probe 125 which is optionally held by a probe holder 110. Probe holder 110 is connected to a cable 120 and connected to apex locator 100 via a connector 160. According to some embodiments, probe 125 may be a file or reamer or a non-motorized probe used for initial root canal measurement.

Apex locator 100 is further connected to a lip hook 130 by a connector 170 and a cable 150. It is noted that any other connection of apex locator 100 to lip hook 130 known in the art may be used. Lip hook 130 is electrically connected to the lip of the patient (or gum or other tissue around the mouth) when probe 125 is inserted into the root canal for closing an electric circuit. In some embodiments, cable 150 is separable by a safety connector 195. Safety connector 195 is adapted to disconnect when pulling the apex locator as a safety measurement in case the operator forgets to remove lip hook 130 from the patient's gum or lip when moving the apex locator to another location.

In operation, apex locator 100 sends an input electric signal through probe holder 110 to probe 125 and processes the returned signals for measuring the distance of the probe from the root canal apex. The signals received in response to the pulse are preferably digitized and processed, for example, as shown in WO 2008/155751 or U.S. Pat. No. 7,326,053, both assigned to MedicN.R.G. Ltd or according to any other method known in the art.

Apex locator 100 preferably includes a display for indicating the distance of the probe from the apex of the root to the operator. This display may include LEDs 105 which light up to indicate the distance or any other visual display of distance. Alternatively or additionally, the apex locator is adapted to generate sound and/or vibrations indicating the distance of the probe from the apex.

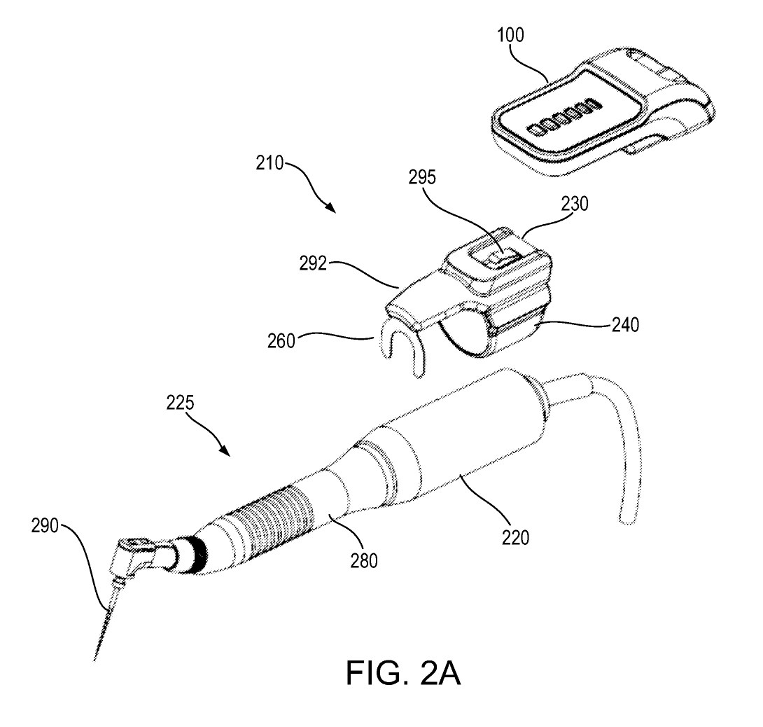

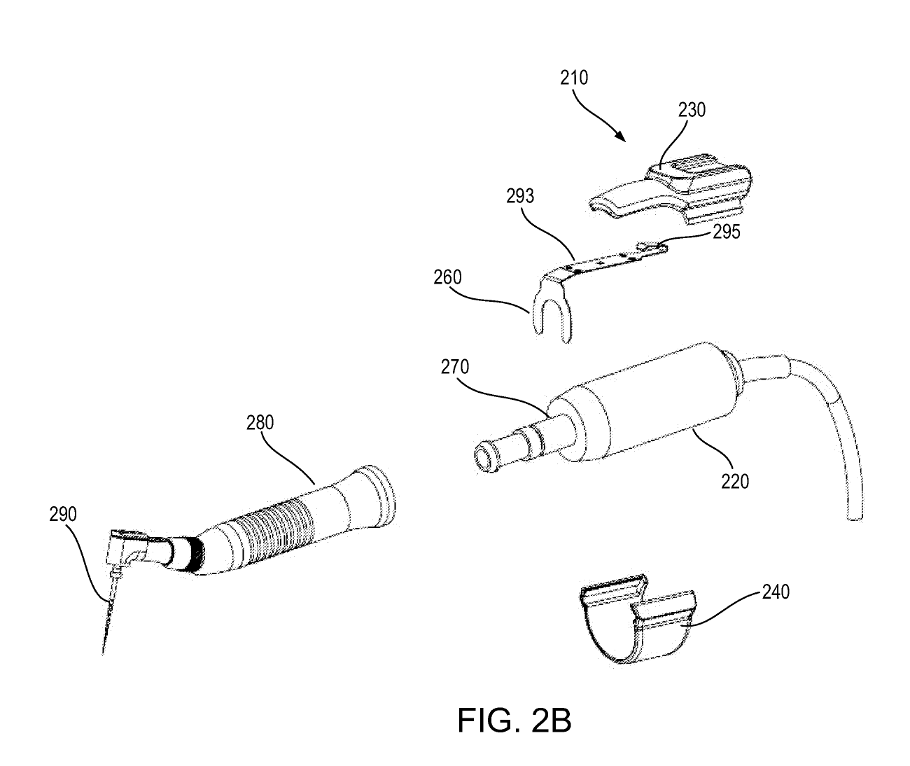

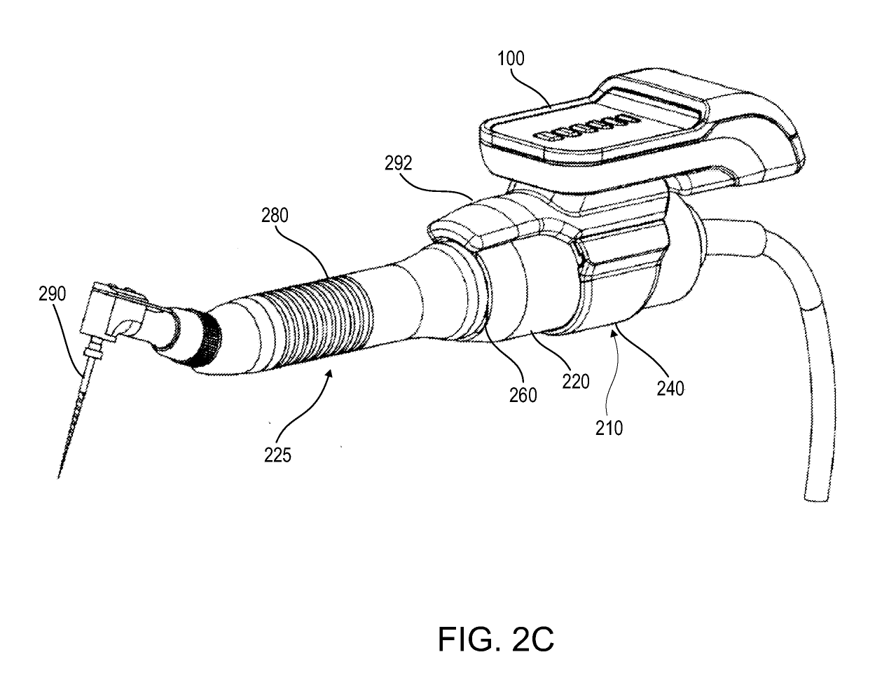

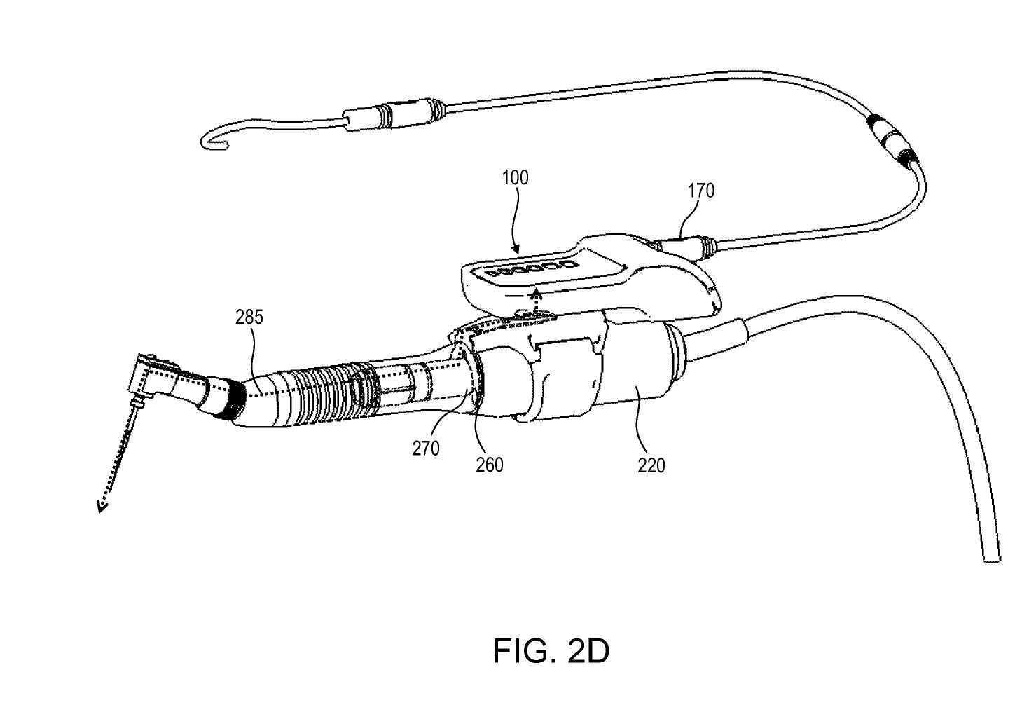

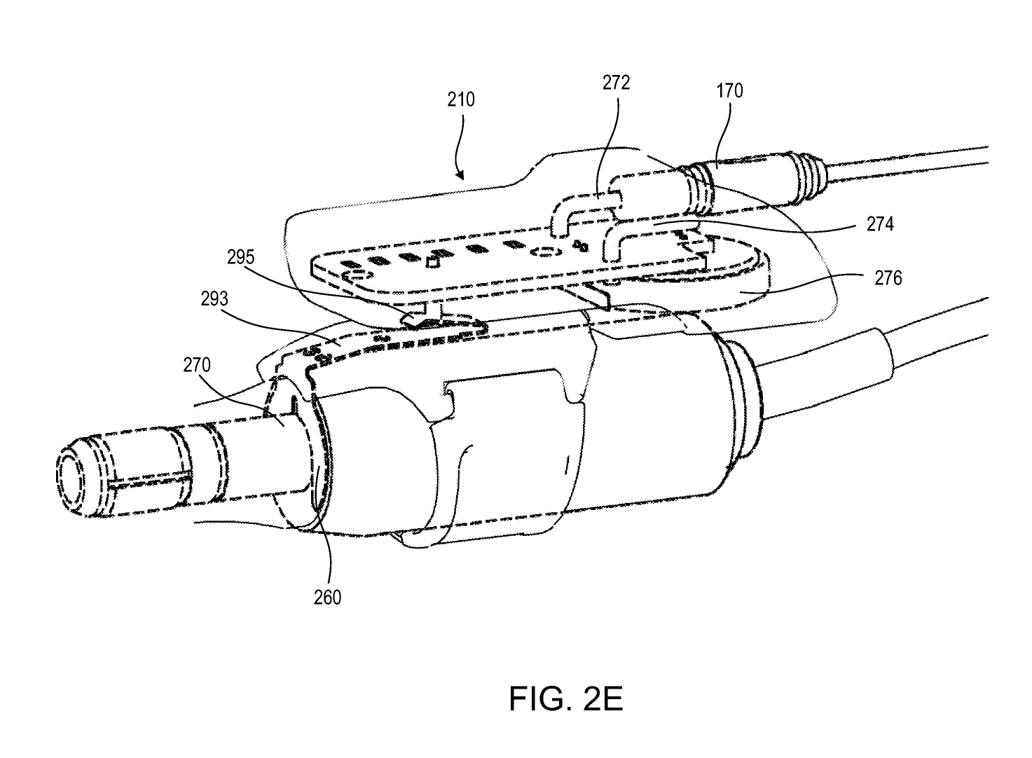

FIGS. 2A and 2B are schematic exploded illustrations of apex locator 100 utilizing an adaptor 210 for connection to a handpiece 225 in accordance with some exemplary embodiments of the invention.

Handpiece 225 includes a body portion or motor 220 and a head 280, holding a file or reamer 290. As shown in FIG. 2B, in typical handpieces used in the art, head 280 is detachable from motor 220, at a motor connector 270.

Adaptor 210 is adapted to be electrically connected to handpiece 225, preferably at motor connector 270. Motor connector 270 is preferably made from a conductive material and serves to provide electrical connection between head 280 and motor 220. In some embodiments, adaptor 225 includes a conductive handpiece connector 260 which is preferably shaped to fit in between motor 220 and head 280 and be in connection with motor connector 270 of handpiece 225. Handpiece connector 260 is shown horse-shoe shaped in FIGS. 2A-2B, however handpiece connector 260 may have any other shape adapted to be mounted on handpiece 225 and electrically connected to file 290. In addition, connector 260 is shown as connected to motor connector 270 from the upper side of the handpiece, however, it is noted that the connection can be made through any side or convenient direction.

In some embodiments of the invention, adaptor 210 electrically connects to other places of handpiece 225, for example by directly connecting to head 280 or file 290.

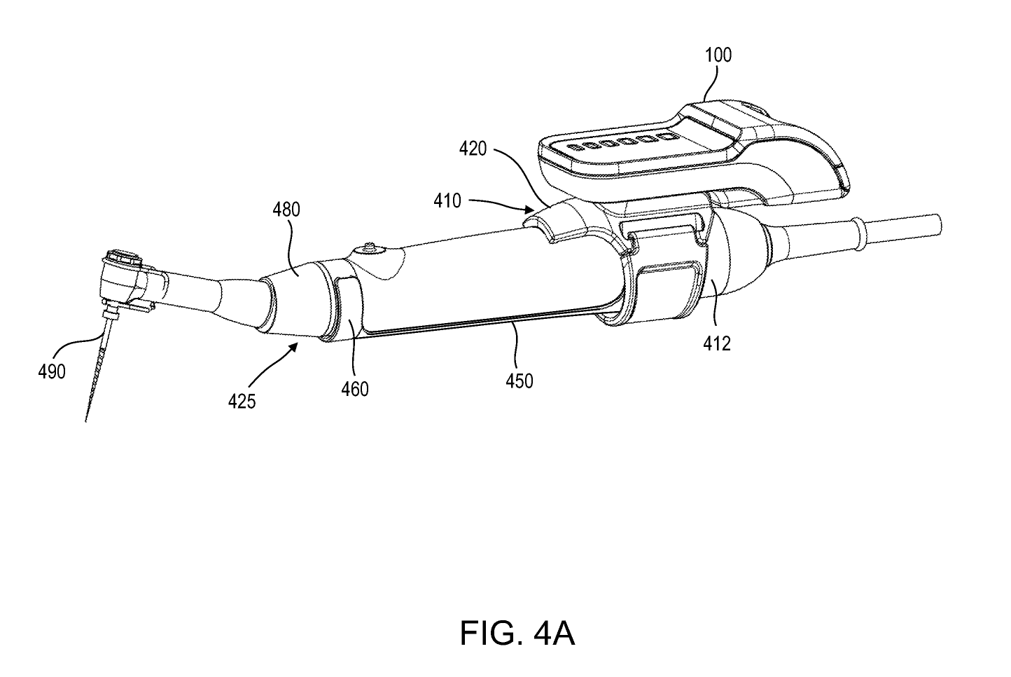

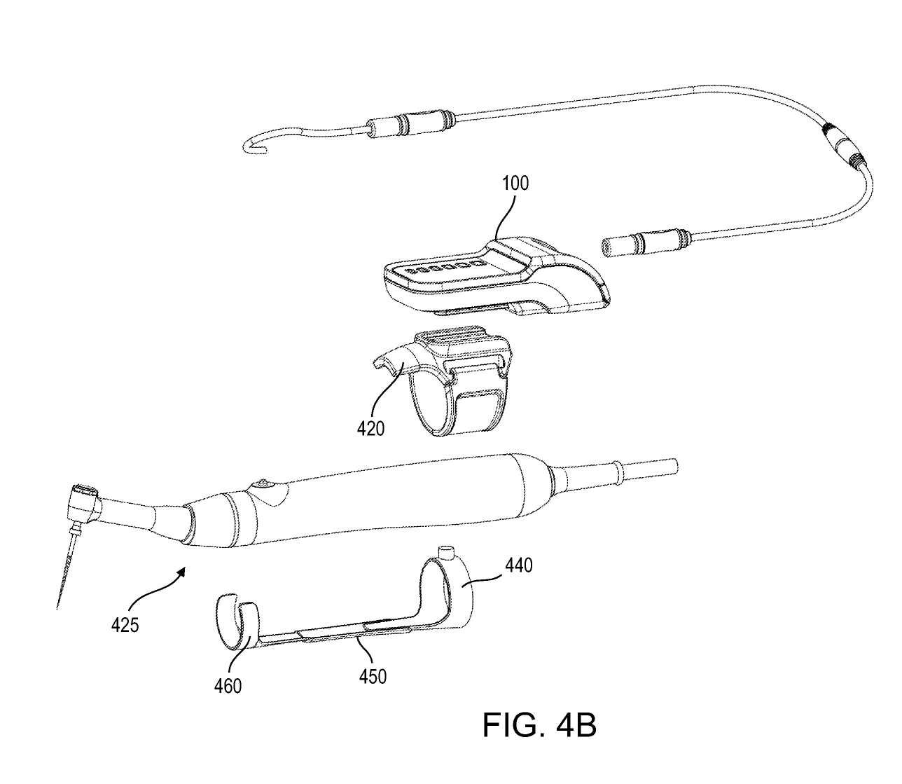

FIGS. 4A and 4B illustrate an adaptor 410 for connecting handpiece 100 to a handpiece 425, having a head 480 holding a file or reamer 490. Adaptor 410 has a handpiece connector 260 which is connected to handpiece 425 at the external surface of head 480. In typical handpieces used in the art, the external surface of the head is made of a conductive material. Accordingly, the connection of adaptor 410 to the external surface of head 480 provides an electrical connection of the adaptor to file 490.

In some embodiments, as shown in FIG. 4A, adaptor 410 is removably mechanically mounted at a distal end 412 of handpiece 425. Adaptor 410 includes a main body 420 and an elongate element 450. Elongate element 450 attaches handpiece connector 460 to main body 420 of adaptor 410. Alternatively, main body 420 and elongate element 450 are separately mechanically mounted on handpiece 425, for example, elongate element 450 may be mounted on handpiece 425 by a ring 440 and thereby electrically connect to main body 420 and/or to apex locator 100. In some embodiments, the length of elongate element 410 can be adapted as desired in order to fit to the distance between head 480 and distal end 412. Optionally, the diameter of handpiece connector 460 and optional ring 440 can also be adapted as desired to fit the diameter of handpiece 425.

In other embodiments of the invention, adaptor 410 may be mechanically mounted on handpiece 425 near to head 480 so that no elongate element 450 is required.

The embodiment shown in FIG. 4 may be used with handpieces where the head and motor are not easily detachable.

Referring back to FIGS. 2A and 2B, electrical connection of adaptor 210 at handpiece connector 260 optionally does not interfere with the normal operation of handpiece 225 and preferably, has no control of the operation of motor 220 at all.

In some embodiments, handpiece connector 260 is connected with a strip 293 to an apex locator connector 295. Apex locator 100 is adapted to be electrically connected to connector 295, connecting its electric circuit with connector 295. Handpiece connector 260, strip 293 and apex locator connector 295 are preferably made from a conductive material, such as metal, in order to allow electric connection between apex locator 100 and handpiece 225.

Adaptor 210 further optionally includes an upper surface 230 for holding apex locator 100 in place during treatment and measurement. Upper surface 230 preferably only covers or encases strip 293, allowing apex locator connector 295 to connect to a mating connection on apex locator 100 and motor connector 260 to connect to handpiece 225.

Adaptor 210 is preferably also removably mechanically mounted onto handpiece 225. In some embodiments, adaptor 210 further includes a strap 240 for fastening around handpiece 225 and stabilizing the mechanical mounting of adaptor 210 to handpiece 225. Strap 240 may have a fixed shaped adapted to fit on standard handpieces or be designed to adapt its shape to the handpiece it is attached to. For example, strap 240 may be made from an elastic material which is adapted to stretch according to the diameter of the handpiece it is attached to. In some embodiments, strap 240 may be closed by a belt or Velcro according to the desired diameter. In some embodiments, a mechanical adaptor may be used to assure a solid fit of apex locator 200 onto handpiece 225. Any removable mounting means known in the art may be used to mount adaptor 210 onto handpiece 225.

Upper surface 230 and strap 240 are preferably made from a non-conductive material in order to prevent electrification of the operator.

FIG. 2C shows apex locator 100 connected to handpiece 225 via adaptor 210. Adaptor 210 is shown mounted onto handpiece 225 and apex locator is shown mounted on adaptor 210. It is noted that in some embodiments of the invention, adaptor 210 and apex locator 100 are an integral unit, having a common housing.

Apex locator 100 operates as described with respect to FIG. 1 above. It is noted that a lip hook is generally used in order to close the electric circuit. A lip-hook as shown in FIG. 1 is generally connected to apex locator 100, optionally as shown in FIG. 1.

As described above, in some embodiments, apex locator 100 may generate sounds or vibrations for indication of the distance between the file and the apex. In some embodiments, the operator may mute the sound or vibrations during treatment by tilting the apex locator (and optionally handpiece on which it is mounted), for example by 180°. The sound may be turned on by tilting the apex locator again.

FIG. 2D shows the electrical connection between handpiece 225 and apex locator 100 when connected via adaptor 210. An exemplary electrical conductive path is shown as dotted-line/arrow 285 connecting apex locator 100 with file 290.

FIG. 2E is a closer and partially cut-away view of the connection shown in FIG. 2D. Adaptor 210 includes an outlet 272 for connecting connector 170 with the lip hook. Adaptor 210 optionally further includes an additional outlet 274 whereto a file can be connected, as shown in FIG. 1. As shown in FIG. 2E, outlet 274 is electrically connected with apex locator connector 295 on adaptor 210.

In some embodiments, apex locator 100 also includes a battery 276 and is not required to be connected to an external power source.

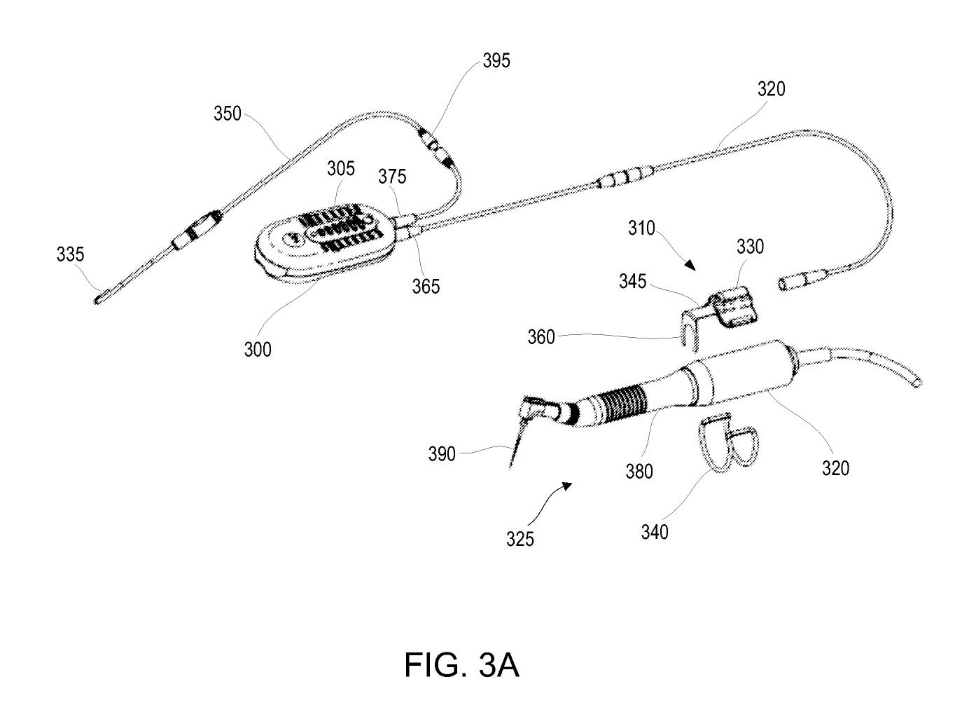

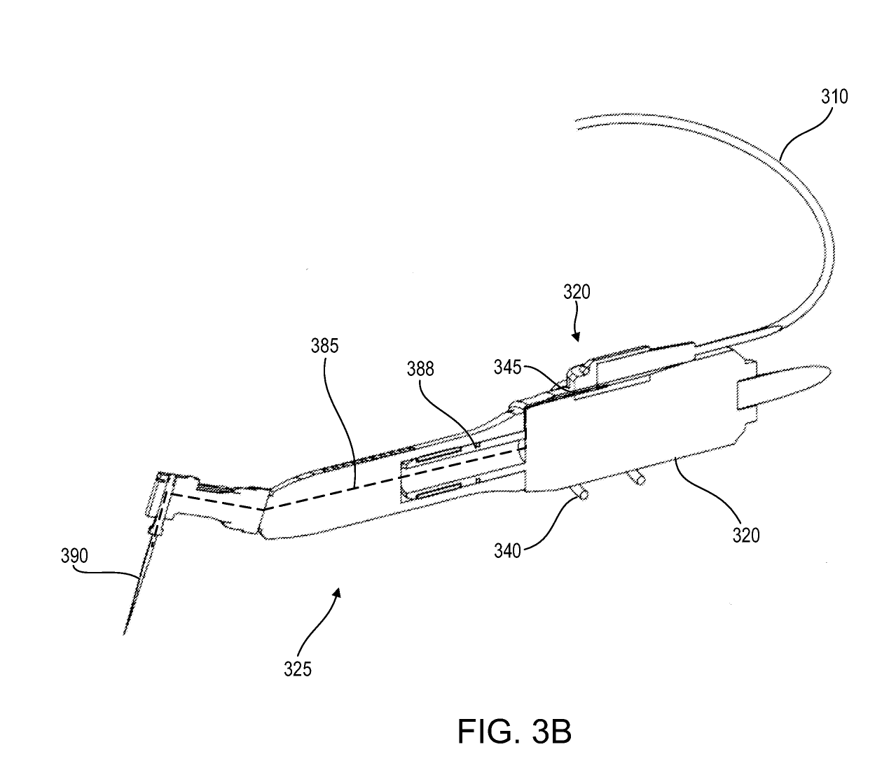

FIG. 3A is a schematic illustration of an apex locator 300 and an associated adaptor 320 for connection to a handpiece 325 in accordance with other exemplary embodiments of the invention. The embodiments shown in FIG. 3A differs from the embodiments shown in FIGS. 2A-2E in that the apex locator is not mechanically mounted on the handpiece by an adaptor but rather connected by a cable to the adaptor. In the embodiments of FIG. 3A the apex locator may be positioned anywhere suitable for the operator to view the display on the apex locator.

Apex locator 300 is shown connected to adaptor 320 by a cable 320 having a connector 365. Adaptor 310 is shown mounted on handpiece 325. Cable 320 is optionally connected to a conductive strip 345 of adaptor 310 having a handpiece connector 360 for connecting to handpiece 325. Similar to handpiece connector 260 shown and described with respect to FIGS. 2A-2E, handpiece connector 360 is optionally adapted to fit between a motor 320 and a head 380 of handpiece 325. Adaptor 310 provides electric connection between apex locator 300 and a file 390.

Adaptor 310 further optionally includes a non-conductive upper surface 330 for holding cable 320 and a strap 340 for grasping around handpiece 325. Upper surface 330 and strap 340 are similar to upper surface 230 and strap 240 described with respect to FIG. 2 above.

Apex locator 300 is further preferably connected to a lip hook 335 by a connector 375 and a cable 350. Lip hook 335 is electrically connected to the lip of the patient, or gum or other tissue around the mouth, when file 390 is inserted into the root canal for closing an electric circuit. In some embodiments, cable 350 is separable by a safety connector 395. Safety connector 395 is adapted to disconnect when pulling the apex locator or handpiece as a safety measurement in case the operator forgets to remove lip hook 335 from the patient's gum or lip.

Apex locator 300 optionally includes a display for indicating the distance of the probe from the apex to the operator. This display may include LEDs 305 which light up to indicate the distance or any other visual display of distance. Alternatively or additionally, apex locator 300 is adapted to generate sound or vibrations indicating the distance of the probe from the apex.

It is noted that apex locator 300 shown in FIG. 3A is shown as designed slightly different than apex locator 100 shown in FIGS. 1 and 2. These designs are for illustrative purposes only. Any design of an apex locator known in the art may be used by different embodiments of the present invention.

FIG. 3B is a partially sectioned schematic illustration of adaptor 320 mounted and connected to handpiece 325. An electric conductance path 385 is shown as a dashed line indicating the electric connection of probe 390 to adaptor 320 and cable 310.

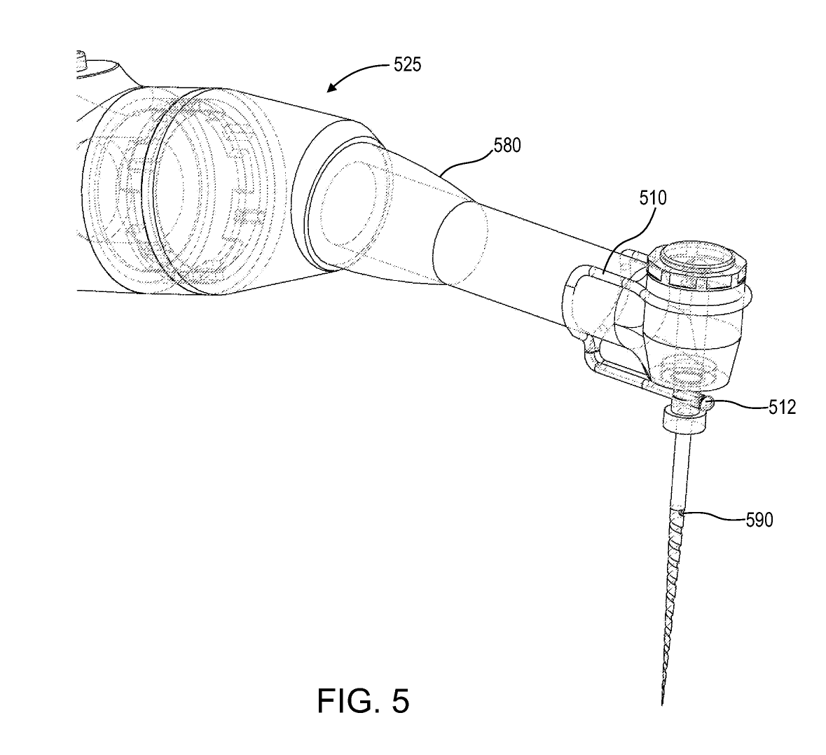

In some existing handpieces, the file of the handpiece is not electrically connected to an easily accessible portion of the handpiece. In some embodiments of the invention, a brush or sheet spring is used for electrically connecting the file to the handpiece. An exemplary brush 510, according to some embodiments of the invention, is shown in FIG. 5. A handpiece 525 having a head 580 and holding a file 590 is shown. Brush 510 electrically connects to a file 590 at 512 and is mounted around head 580. In some embodiments, brush 510 is electrically connected to the motor using a conductive material from which the head is made. In other embodiments, brush 510 is electrically connected to the motor or adaptor using tubes, wires or other known electrical conducting means.

It is expected that during the life of a patent maturing from this application many relevant apex locators, apex locating methods and handpieces will be developed and the scope of the invention is intended to include all such new technologies a priori.

As used herein the term “about” refers to ±10%

The terms “comprises”, “comprising”, “includes”, “including”, “having” and their conjugates mean “including but not limited to”.

The term “consisting of means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, an and the include plural references unless the context clearly dictates otherwise.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

1.-28. (canceled)

29. A method of removably connecting an apex locator to a handpiece, the method comprising:
accessing a space between a motor and a head of a handpiece; and
electrically connecting an apex locator through said space to a file or reamer held by said head.

30. A method according to claim 29, wherein electrically connecting an apex locator comprises mounting an adaptor in said space and connecting said adaptor to the apex locator by a cable.

31. A method according to claim 29, wherein electrically connecting an apex locator comprises mounting an adaptor in said space and mechanically mounting the apex locator on said adaptor.

32. A method according to claim 31, wherein mounting comprises removably mounting.

33. A method according to claim 29, the method further comprising:
measuring, by the apex locator, a root apex using signals received from the file or reamer.

34. A method according to claim 29, further comprising:
disconnecting said apex locator from said head.

35. A method according to claim 29, further comprising:
connecting said apex locator to a lip hook.

36. A kit for removably electrically connecting an apex locator to a file or reamer held by a handpiece, the handpiece comprising a head portion containing the file or reamer and a body portion containing a motor for driving the file or reamer, the kit comprising:
an apex locator connector portion adapted for electrical connection to the apex locator;
a handpiece connector portion adapted for removably electrically connecting to the file or reamer through a space between a head and body portion of the handpiece; and
an electrically conductive portion connecting the apex locator connector portion and the handpiece connector portion.

37. A kit according to claim 36, wherein said electrically conductive portion comprises a cable.

38. A kit according to claim 36, wherein said adaptor is configured to be mounted on the handpiece.

39. A kit according to claim 36, wherein the handpiece connector portion is adapted to connect to handpieces of different diameters.

40. A kit according to claim 36, further comprising a grasp adapted for grasping around the handpiece.

41. A kit for removably electrically connecting an apex locator to a file or reamer held by a handpiece, the handpiece comprising a head portion and a body portion, the head portion comprising a distal end containing the file or reamer and a proximal end connected to a body portion, the body portion containing a motor for driving the file or reamer, the kit comprising:
an apex locator connector portion adapted for electrical connection to the apex locator;
a handpiece connector portion adapted for removably electrically connecting to the file or reamer through the proximal end of the head portion of the handpiece; and
an electrically conductive portion connecting the apex locator connector portion and the handpiece connector portion.

42. A kit according to claim 41, wherein the handpiece connector portion further connects to the external surface of the head portion.

43. A kit according to claim 41, wherein said electrically conductive portion comprises a cable.

44. A kit according to claim 41, wherein said adaptor is configured to be mounted on the handpiece.

45. A kit according to claim 41, wherein the handpiece connector portion is adapted to connect to handpieces of different diameters.

46. A kit according to claim 41, further comprising a grasp adapted for grasping around the handpiece.
